(19) United States
(12) Patent Application Publication
(10) Pub. No.: US 2002/0154067 A1
(43) Pub. Date: Oct. 24, 2002

(54) Anisotropic correction lens for antenna disposed in anisotropic housing and related assemblies

(76) Inventors: Michael A. Gilbert, Santa Barbara, CA (US); Toan L. Do, El Monte, CA (US)

Correspondence Address: NIXON & VANDERHYE P.C., 8th Floor, 1100 North Glebe Road, Arlington, VA, 22201-4714, US

(21) Appl. No.: 10/122,243

(22) Filed: Apr. 16, 2002

Related U.S. Application Data
(60) Provisional application No. 60/285,236, filed on Apr. 23, 2001.

(51) Int. Cl. H01Q 1/36; H01Q 15/02; H01Q 15/24

(52) U.S. Cl. 343/909; 343/895; 343/872

(57) ABSTRACT

The otherwise distorted pattern of an antenna disposed within an anisotropic radome (e.g. of a submarine) is corrected with a complementary anisotropic RF lens.

This application claims the benefit of U.S. Provisional Application Serial No. 60/285,236, which was filed Apr. 23, 2001, the disclosure of which is incorporated herein by this reference

### STATEMENT REGARDING FEDERALLY SPONSORED RESEARCH OR DEVELOPMENT

This invention was conceived as part of a Small Business Innovative Research (SBIR) Program funded by the U.S. Navy under contract N00039-95-C-0067.

### BACKGROUND OF THE INVENTION

This invention relates to antenna systems, specifically to an antenna, including a correcting lens, enclosed within a submarine radome for use in a communication link via satellite.

Submarine communication antennas are commonly enclosed within a radome for protection from seawater. Such radomes are shaped for the smoothest flow through water in the forward direction.

The resulting anisotropic shape of these radomes causes an undesired azimuthal directivity for the communications antennas housed within them. This directivity is generally undesirable, since it leads to reduced antenna gain in some directions, thereby forcing a reduced communication data rate to satellites located in those directions.

As an example, a quadrifilar helix antenna has the omni-directional gain pattern and circular polarization that is normally desirable for submarine communication via satellites. However, when this antenna is housed in a conventional submarine radome, as depicted in FIG. 1, the azimuthal pattern will become distorted (i.e., anisotropic), resulting in reduced gain in some directions. For a right-hand circularly polarized antenna, the minimum gain occurs toward the port (i.e. left) side. And conversely, for a left-hand circularly polarized antenna, the minimum gain occurs on the starboard (i.e. right) side. The maximum available communication data rate may therefore be limited by these minimum gains caused by the radome.

Thus, there is a need to correct for the anisotropic antenna pattern distortion caused by anisotropic submarine radomes. The correction needs to fit within the radome so not to change the fluid flow optimized streamline design of the radome in any way.

### SUMMARY OF INVENTION

Accordingly, the exemplary embodiment of the present invention includes a correcting lens inserted into the submarine radome with the antenna. As shown in FIG. 2, the exemplary correcting lens can be located toward the forward side of the radome. In this location, the lens adds path length to radio waves propagating through the forward side of the radome. This provides its own anisotropic correction that is complementary to the anisotropic distortion of the radome. Thus, the additional path length compensates for the longer path length through the radome in the AFT direction. This complementary anisotropic compensation reduces the anisotropic antenna pattern distortion caused by the radome.

The correcting lens fits within the radome on the outer surface of the antenna, as shown in FIG. 2. The correcting lens is made from a relatively high dielectric constant material. As shown in FIG. 2, it can be made thin enough to fit between a quadrifilar helix antenna and the radome. For example, in the case of an AN/BRA-34 submarine radome, the optimum lens spans about 180 degrees of circular arc, and can be made from 7 mm thick material having a dielectric constant of about 10.

One method of construction for the lens is to bond several layers of dielectric substrate together as shown in FIG. 3A and FIG. 3B. This technique minimizes cost by enabling the use of commonly available circuit substrate materials, and does not require any special machining processes.

The amount of gain pattern distortion caused by a submarine radome at UHF (ultrahigh frequency) typically ranges about 2 to 3 dB as shown by the solid curve in FIG. 4. The correcting lens can reduce this to less than 1 dB, as shown by the dashed curve.

### BRIEF DESCRIPTION OF DRAWINGS

FIG. 1 is a top cross-sectional view of a conventional prior art quadrifilar helix antenna enclosed in a submarine radome.

FIG. 2 shows the location of an exemplary correcting lens within a submarine radome.

FIG. 3A shows a 3-dimensional exploded view of the exemplary quadrifilar helix antenna, correcting lens, and submarine radome.

FIG. 3B shows a detailed 3-dimensional view of the exemplary correcting lens constructed from layers of dielectric substrate.

FIG. 4 shows a comparison between azimuthal antenna patterns with and without the exemplary correcting lens.

FIG. 5A shows an alternative construction technique for an exemplary correcting lens using vertical sections.

FIG. 5B shows an alternative construction technique for an exemplary correcting lens using horizontal sections.

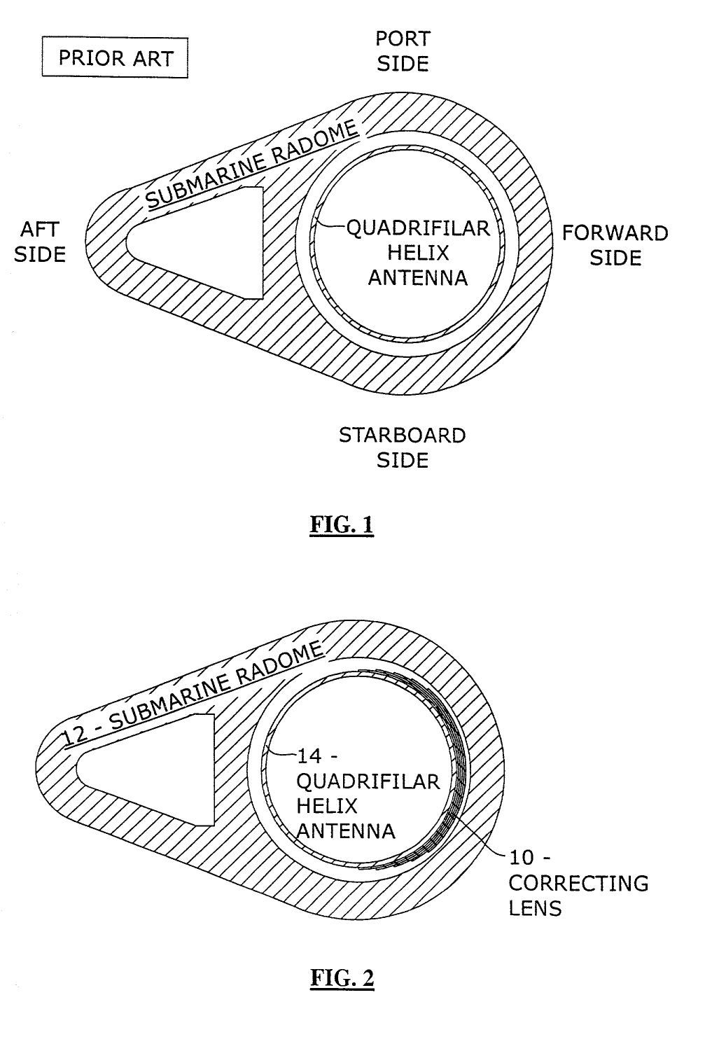

### DETAILED DESCRIPTION OF THE INVENTION

A presently preferred exemplary embodiment of a correcting lens is illustrated in a cross-sectional view in FIG. 2. The correcting lens 10 is located on the forward side of the submarine radome 12. The position of correcting lens 10 is between the outer surface of the quadrifilar helix antenna 14 and the inside surface of the submarine radome 12.

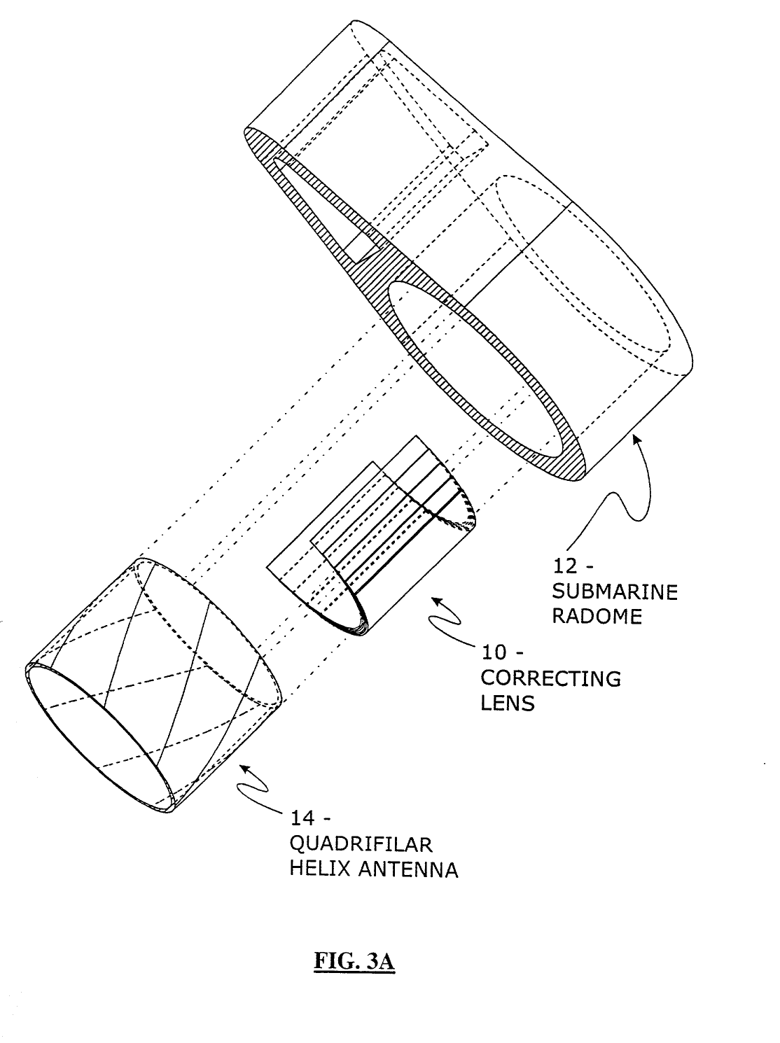

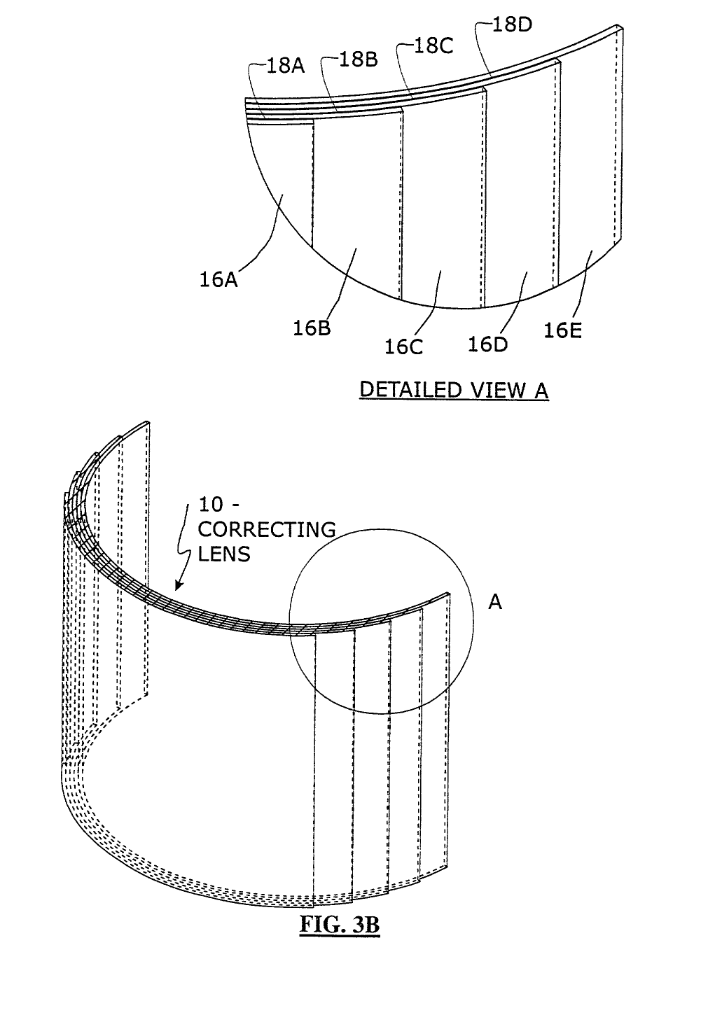

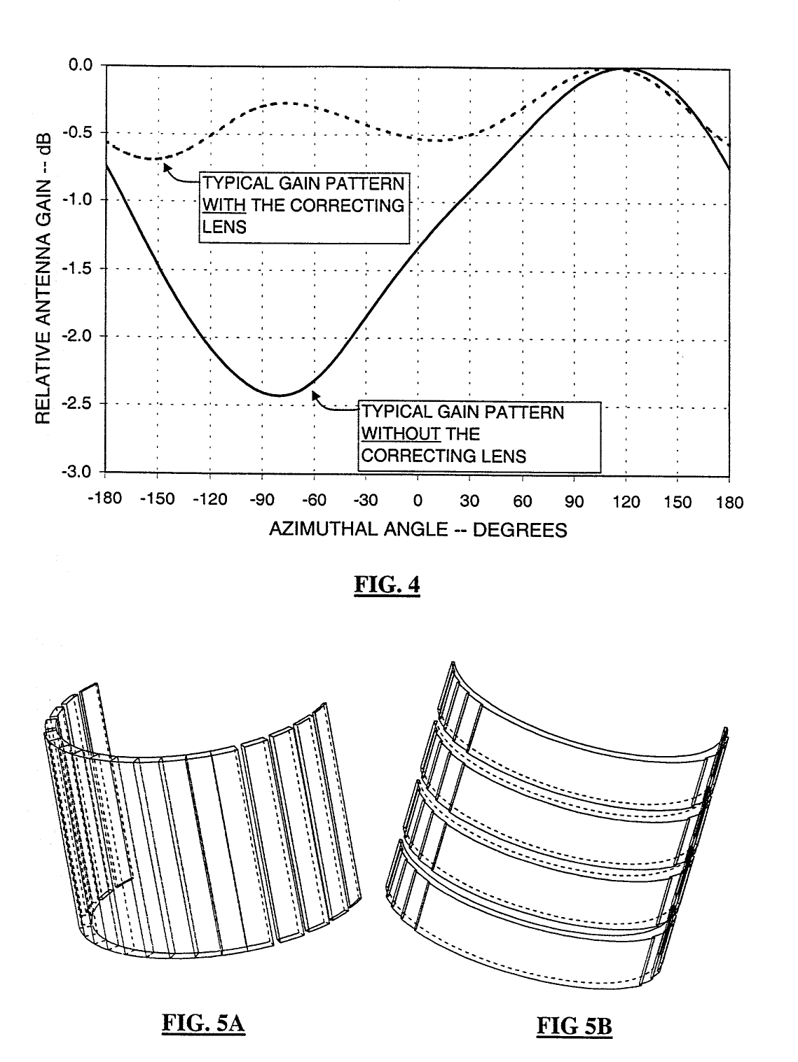

The exemplary correcting lens 10 is illustrated in a perspective view in FIG. 3B. The exemplary lens uses five layers of the flexible dielectric sheets, 16A, 16B, 16C, 16D, and 16E, such as RO3010™ available from Rogers Corporation of Chandler, Ariz. However the dielectric sheets can be made (in whole or in part) of any other material that has a high relative dielectric constant and can be bent without fracturing.

Between the layers of flexible dielectric sheets are layers of adhesives, 18A, 18B, 18C, and 18D, such as 3M F-9469PC Adhesive Transfer Tape available from 3M of St. Paul, Minn. However the adhesives can include any other adhesive (in whole or in part) that is relatively thin, flexible and having good adhesion to the dielectric material.

On the exemplary embodiment, each layer of dielectric sheet is typically 1.3 mm in thickness. Each layer of adhesive is typically 0.13 mm in thickness. The overall thickness of the exemplary correcting lens is roughly 7.0 mm. The angular extent of the lens is typically 180 degrees of circular arc.

In constructing the exemplary correcting lens, the layers of flexible dielectric sheets are wrapped around and bonded together on a circular mandrel. The resulting diameter of the correcting lens is typically 14 cm enabling it to fit within an AN/BRA-34 submarine radome.

At each end of the exemplary correcting lens, the overall thickness is tapered gradually down to a single layer, as shown in FIG. 3A. Each dielectric sheet is reduced in width by typically 20 degrees of circular arc relative to the layer it is bonded onto.

The exemplary correcting lens 10, shown in FIG. 2, compensates, in the FORWARD direction, for the excess path length for signals traversing in the AFT direction of the submarine radome 12. The correcting lens 10 is thin enough (˜1/100^{th} of the free-space radio-wave wavelength) so as to permit easy installation within an existing submarine radome 12. The forward location of the lens 10 corrects for antenna pattern distortions in the Port-Starboard plane.

There are various possibilities with regard to the design of the correcting lens. By non-limiting example, the thickest portion may generally be in the forward direction. The thickness may generally taper off to zero at angles near +/−90 degrees from forward. These exemplary characteristics follow the shape of the submarine radome 12, shown in FIG. 2. As shown in FIG. 2, a typical submarine radome has two dielectric walls to traverse in the AFT direction and only one in the forward direction. Any lens that helps balance out the AFT/FWD path lengths will result in a more balanced and omni-directional antenna pattern.

There are in general at least four exemplary design parameters for a correcting lens. These are 1) the location of the lens, 2) the angular extent of the lens, 3) the dielectric constant of the lens material and 4) the thickness of the lens. A general discussion of these four exemplary design parameters is provided below:

1) Location of the lens

As was stated above, the exemplary lens is centered about the forward direction. The radial position, however, can be selected according to the demands of the particular application. Normally the preferred position would be inside the radome to minimize the impact on the radome design. The correcting lens could, however, be designed as an attachment to the outside of the radome or even integrated within the radome wall.

2) Angular extent of the lens

The angular extent of the exemplary lens will generally be limited to the forward half of the antenna. The optimum arc length for the lens ranges from about 140 degrees to 180 degrees. The thickness can be made uniform over the entire angular range, however, some improvement in antenna pattern balance is realized by tapering the edges gradually to zero. For an AN/BRA-34 radome, the optimum angular extent is about 160 degrees for a non-tapered design and about 180 degrees for a tapered design.

3) Dielectric constant of the lens

The dielectric constant of the exemplary lens is generally chosen high enough to keep the thickness below a required limit. The upper bound on the dielectric constant is generally limited to the availability of suitable materials. For the preferred embodiment, the material having the highest dielectric constant and sufficient flexibility was selected. This material, RO3010™, has a dielectric constant of 10.2. When flexibility is not a concern, higher dielectric constant materials could be considered, and would result in a thinner lens design. In addition to uniform materials, the lens could be constructed using artificial dielectrics. These materials are formed by embedding metallic objects within low dielectric materials, such as a foam or a resin. One advantage of using artificial dielectrics is that the dielectric constant can be made anisotropic. The anisotropic dielectric constant could in theory provide a better correcting lens design than one using a uniform material. The trade-off against using artificial dielectrics is the increased cost and complexity of these materials.

4) Thickness of the lens

The exemplary lens has an optimum thickness. For thickness values less than the optimum, the antenna pattern is only partially corrected. For thickness values greater than the optimum, the antenna pattern is over corrected and can even be made more unbalanced than a design without any lens. For the AN/BRA-34 radome the optimum thickness is about 7 mm, when using a dielectric constant of 10.2 and when the lens is placed directly on the surface of a quadrifilar helix antenna. The optimum thickness would be decreased when using a higher dielectric constant material or increased when using a lower dielectric constant material. In addition the thickness of the lens varies with the proximity to the antenna. When the lens is located further from the antenna, for example outside the radome, the thickness needs to be increased. The reason for this is that the currents on the antenna are coupled more weakly into the lens the further it is located from the antenna.

There are also various possibilities with regard to the construction of a correcting lens. The lens could be built-up from vertical sections as shown in FIG. 5A, or from horizontal sections as shown in FIG. 5B. Alternatively, the correcting lens could be machined or cast as a single solid unit. Advantages of the layered construction in the preferred exemplary embodiment include reduced cost of the material and simplicity of fabrication. Alternative construction techniques could be best utilized when using non-flexible materials for the lens dielectric.

As those in the art will appreciate, many modifications and/or variations may be made in the exemplary embodiments while yet retaining at least some of the novel features and advantages of the invention. All such modifications and variations are intended to be included within the scope of the following claims.

What is claimed is:

1. An RF antenna assembly for installation in an anisotropic housing, said assembly comprising:
an RF antenna having a radiation pattern that would be anisotropically altered by installation in said housing; and
an anisotropic correcting RF lens coupled to said antenna structure so as to complement and at least partially reduce the degree of anisotropic pattern alteration that otherwise would be introduced by said housing.

2. An assembly as in claim 1, wherein:
said radiation pattern is approximately omni-directional before being distorted by installation in said anisotropic housing; and
said correcting lens introduces complementary anisotropic correction that at least partially restores an omni-directional radiation pattern to the composite assembly when installed in said housing.

3. An assembly as in claim 2 further comprising:
said anisotropic housing in which said antenna and lens are internally disposed.

4. An assembly as in claim 3 wherein said housing is a submarine radome anisotropically shaped for optimum passage through water.

5. An assembly as in claim 1 wherein said antenna comprises a quadrifilar helix antenna.

6. An assembly as in claim 5 wherein said lens comprises a varying thickness of dielectric disposed outside and around at least a portion of the circumference of said quadrifilar helix antenna.

7. An assembly as in claim 6 wherein said varying thickness of dielectric includes multiple segments or layers of dielectric adhesively affixed with respect to one another.

8. An assembly as in claim 6 wherein said varying thickness of dielectric is formed of one unitary member.

9. An assembly as in claim 1 wherein said lens comprises an artificial dielectric composite material having an anisotropic dielectric constant.

10. An assembly as in claim 1 wherein said housing is a submarine radome having a greater RF signal propagation distance in an aft direction than in a forward direction and wherein said lens effectively provides a greater RF signal propagation distance in a forward direction than in an aft direction.

11. A method for reducing anisotropic distortion in an RF antenna radiation pattern when said antenna is housed within an anisotropic housing having a greater RF signal propagation distance in a first direction than in a second direction said method comprising:
disposing a complementary anisotropic corrective RF lens structure between said antenna and said housing;
said lens structure being RF coupled to said antenna and effectively providing a greater RF signal propagation distance in said second direction than in said first direction.

12. A method as in claim 11, wherein:
said radiation pattern is approximately omni-directional before being distorted by installation in said anisotropic housing; and
said correcting lens introduces complementary anisotropic correction that at least partially restores an omni-directional radiation pattern to the composite assembly when installed in said housing.

13. A method as in claim 12 wherein:
said housing is a submarine radome shaped for optimum passage through water.

14. A method as in claim 11 wherein said antenna comprises a of quadrifilar helix antenna.

15. A method as in claim 14 wherein said lens comprises a varying thickness of dielectric disposed outside and around at least a portion of the circumference of said quadrifilar helix antenna.

16. A method as in claim 15 wherein said varying thickness of dielectric includes multiple segments or layers of dielectric adhesively affixed with respect to one another.

17. A method as in claim 15 wherein said varying thickness of dielectric is formed of one unitary member.

18. A method as in claim 11 wherein said lens comprises an artificial dielectric composite material having an anisotropic dielectric constant.

19. A method as in claim 11 wherein said housing is a submarine radome having a greater RF signal propagation distance in an aft direction than in a forward direction and wherein said lens effectively provides a greater RF signal propagation distance in a forward direction than in an aft direction.

20. A correcting lens for use with an antenna disposed within a submarine radome, said correcting lens comprising a shaped structure made from high dielectric constant material and disposed to present a greater thickness at a forward side of the antenna.

21. A correcting lens as in claim 20, said correcting lens spanning about 180 degrees of circular arc in an azimuthal plane.

22. A correcting lens as in claim 20, said correcting lens being juxtaposed with a forward outer surface of the antenna.

23. A correcting lens as in claim 22, said correcting lens being about 7 mm thick at its thickest part.

24. A correcting lens as in claim 23, said correcting lens being made of a plurality of layers of flexible dielectric sheets, said plurality of flexible sheets being held together by adhesive disposed between adjacent ones of said plurality of flexible sheets.

25. A correcting lens as in claim 24, each one of said flexible dielectric sheets being about 1.3 mm in thickness and said flexible dielectric sheets being attached to each other in overlapping fashion in an arc such that a thickest portion said correcting lens is approximately 7.0 mm thick.

26. A correcting lens as in claim 25, wherein the thickness of said correcting lens tapers gradually down to a reduced thickness but still of at least one flexible dielectric sheet thickness at outermost portions of the arc.

27. A correcting lens as in claim 20, the arc length of said correcting lens in an azimuthal plane ranging from 140 degrees to 180 degrees.

28. A correcting lens as in claim 26, the arc length of said correcting lens in an azimuthal plane being 180 degrees.

29. A correcting lens as in claim 20, the arc length of said correcting lens in an azimuthal plane being 160 degrees.

30. A correcting lens as in claim 27, the relative dielectric constant of the material forming said correcting lens being at least approximately 10.

31. A correcting lens as in claim 20, said correcting lens being formed by sections of said dielectric material that are elongated in a direction approximately perpendicular to an azimuthal plane.

32. A correcting lens as in claim 20, said correcting lens being formed by sections of said dielectric material that are elongated in a direction approximately parallel to an azimuthal plane.

33. A method for making a correcting lens for use with an antenna disposed within a submarine radome, said method comprising:
bonding a plurality of layers of dielectric material together around a mandrel to create an arc-shaped correcting lens, and
positioning said correcting lens at a forward side of the antenna.

34. A method as in claim 33, said correcting lens including at least about 180 degrees of circular arc in an azimuthal plane.

35. A method as in claim 33, said correcting lens being fitted to a forward outer surface of the antenna.

36. A method as in claim 33, said plurality of layers of dielectric material being bonded together by adhesive disposed between adjacent ones of said plurality of layers of dielectric material.

37. A method as in claim 36, each one of said plurality of layers of dielectric material being about 1.3 mm in thickness and said plurality of layers of dielectric material being disposed in overlapping fashion in an azimuthal arc such that a thickest portion of said correcting lens is approximately 7.0 mm thick.

38. A method as in claim 37, wherein the thickness of said correcting lens tapers gradually down to a reduced thickness but still of at least one layer of dielectric material at outermost portions of the arc.

39. A method as in claim 38, said correcting lens including about 180 degrees of circular arc in an azimuthal plane.

40. A method as in claim 33, the relative dielectric constant of said dielectric material being at least approximately 10.

41. A method of making a correcting lens for use with an antenna disposed within a submarine radome, said method comprising:
building up a plurality of sections of dielectric material around a mandrel to create an arc-shaped correcting lens, and
positioning said correcting lens at a forward side of the antenna.

42. A method of making a correcting lens as in claim 41, said plurality of sections of dielectric material being horizontal sections.

43. A method as in claim 41, said correcting lens spanning about 180 degrees of arc.

44. A method as in claim 41, said correcting lens having a maximum thickness of about 7 mm.
